(19) United States
(12) Patent Application Publication
(10) Pub. No.: US 2026/0044788 A1
(43) Pub. Date: Feb. 12, 2026

(54) AUTOMATIC ROOM ASSIGNMENT METHOD AND SYSTEM BASED ON REAL-TIME ROOM SALES INFORMATION AND ROOM STATUS INFORMATION

(71) Applicant: VENDIT Inc., Seoul (KR)

(72) Inventors: Jun Gyu LEE, Gwangmyeong-si (KR); Eun Gyu LEE, Gwangmyeong-si (KR)

(21) Appl. No.: 19/289,073

(22) Filed: Aug. 3, 2025

(30) Foreign Application Priority Data
Aug. 12, 2024 (KR) 10-2024-0107513

(51) Int. Cl. G06Q 10/02; G06Q 50/12

(52) U.S. Cl. CPC G06Q 10/02; G06Q 50/12

(57) ABSTRACT

The present invention relates to an automatic room assignment method based on real-time room sales information and room status information. The method comprises: selecting, by a reservation management server, a reservation requiring room assignment; selecting, by the reservation management server, an assignable room based on the reservation information; assigning the room to the reservation; and transmitting, by the reservation management server, room assignment completion to a user terminal when the room is successfully assigned, or transmitting assignment failure and failure-related information to the user terminal when the room assignment fails.

### TECHNICAL FIELD

The present invention relates to an automatic room assignment method and system based on real-time room sales information and room status information, and more particularly, to a method and system that automatically assigns rooms by collecting and analyzing real-time data of rooms that have been sold or are scheduled to be sold.

### BACKGROUND

Conventionally, hotel room assignments have been performed manually. Hotel staff would verify each reservation individually and assign a room through a room management system, such as Excel-based tools. When a reservation is confirmed through a booking platform, the staff must manually check available rooms and assign one accordingly.

This manual process is time-consuming, prone to error, and requires substantial effort and attention to meet individual customer preferences.

Korean Patent No. 10-0985939 discloses a hotel room sales and management system, but it primarily focuses on operations involving multiple individual room owners who sell or lease hotel or residence rooms via dedicated management servers. It provides a method of operating such hotel rooms based on client information but does not address real-time automatic assignment based on aggregated room sales and status data.

### SUMMARY

The present invention aims to provide an automatic room assignment method and system that collects and analyzes real-time room sales information and room status data to automatically assign rooms.

The method comprises selecting, by a reservation management server, a reservation that requires room assignment, selecting assignable rooms based on reservation data, assigning a corresponding room, transmitting assignment success to a user terminal if assignment is successful, transmitting assignment failure and related information to a user terminal if assignment fails.

The system comprises a reservation management server configured to receive and store real-time reservation and room status information, identify reservations requiring assignment, and perform the assignment, a broker server that collects and transmits real-time reservation data, a room control server that collects and transmits real-time room status data, and a user terminal that receives assignment completion, failure, or failure information.

### Advantageous Effects

According to the present invention, reservations requiring room assignment can be selected based on real-time reservation information received from various reservation brokerage servers.

Moreover, assignable rooms can be selected based on both the reservation information of such reservations and real-time room status information.

Furthermore, the system can automatically assign rooms corresponding to the selected reservation.

### BRIEF DESCRIPTION OF THE DRAWINGS

FIG. 1 is a flowchart illustrating an automatic room assignment method based on real-time room sales information and room status information, according to an embodiment of the present invention.

FIG. 2 is a flowchart illustrating a method of selecting a reservation requiring room assignment by a reservation management server, according to an embodiment of the present invention.

FIG. 3 is a flowchart illustrating a method of selecting assignable rooms based on reservation information corresponding to the selected reservation, according to an embodiment of the present invention.

FIG. 4 is a block diagram illustrating a configuration of an automatic room assignment system based on real-time room sales information and room status information, according to an embodiment of the present invention.

### DETAILED DESCRIPTION

The specific structural or functional descriptions for the embodiments in accordance with the inventive concept disclosed herein are merely illustrative for the purpose of describing the embodiments in accordance the inventive concepts, which may be embodied in various forms and are not limited to the embodiments described herein.

Embodiments in accordance with the present inventive concept may be subject to various modifications and take various forms, and thus embodiments are illustrated in the drawings and described in detail herein. However, this is not intended to limit embodiments in accordance with the inventive concept to the specific disclosed forms, and includes all modifications, equivalents, or alternatives included in the spirit and technical scope of the present invention.

The terminology used herein is for the purpose of describing particular embodiments only and is not intended to be limiting of the invention. The singular forms “a,” “an,” and “the” include plural referents unless the context clearly dictates otherwise. It will be further understood that the terms “comprises,” “comprising,” “includes,” “including,” “having,” and the like, when used in this specification, specify the presence of stated features, integers, steps, operations, elements, components, or combinations thereof, but do not preclude the presence or addition of one or more other features, integers or steps, operations or elements, components or combinations thereof.

Embodiments of the present invention will now be described in detail with reference to the accompanying drawings.

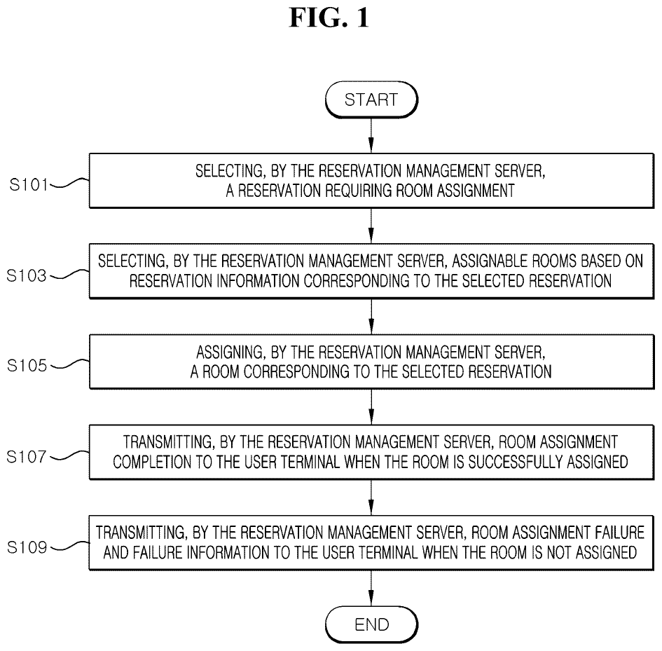

FIG. 1 is a flowchart illustrating an automatic room assignment method based on real-time room sales information and room status information, according to an embodiment of the present invention.

Referring to FIG. 1, in step S101, the reservation management server 100 selects reservations that require room assignment. In step S103, the reservation management server 100 selects assignable rooms based on the reservation information corresponding to the selected reservation. Then, in step S105, the reservation management server 100 assigns the rooms corresponding to the selected reservation.

When the room selection is completed, the reservation management server 100 may assign the room to the target reservation based on the reservation information and a room assignment algorithm. The room assignment algorithm may be an optimization algorithm for matching the most suitable room to the target reservation and may attempt to automatically assign the most appropriate room for each reservation. The algorithm may be based on techniques such as multiple-criteria decision making (MCDM), machine learning algorithms, or traditional rule-based classification algorithms, but is not limited thereto.

In step S107, when the room is successfully assigned, the reservation management server 100 transmits a room assignment completion message to the user terminal 400. Along with the assignment completion, the reservation management server 100 may transmit room usage information such as the available time of use for the assigned room (e.g., check-in and check-out time).

In step S109, if the room is not assigned, the reservation management server 100 transmits a room assignment failure message and corresponding failure information to the user terminal 400. After transmitting the room assignment failure and failure information to the user terminal 400, the reservation management server 100 may additionally transmit procedures for completing the room assignment. These additional procedures may include, for example, methods for reattempting room assignment when a room was not found, methods for analyzing and correcting the reason for the failure to enable reassignment, or alternative server usage methods in case of failure due to errors in the broker server 200. The failure information may include the reason for the failure in room assignment.

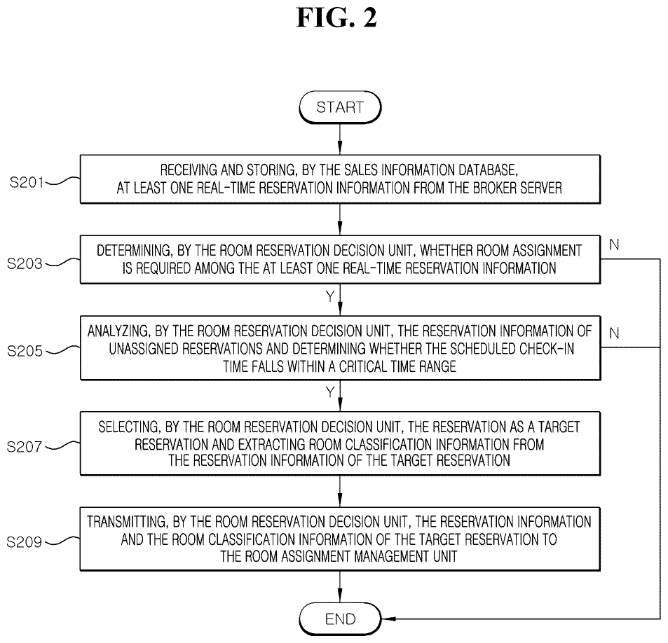

FIG. 2 is a flowchart illustrating a method by which the reservation management server selects reservations requiring room assignment, according to an embodiment of the present invention.

Referring to FIG. 2, in step S201, the sales information database 110 receives and stores at least one real-time reservation information from the broker server 200. The broker server 200 is a server that transmits real-time reservation data related to room sales to the reservation management server 100. It may collect information on accommodation products sold by multiple lodging providers via one or more external OTA (Online Travel Agency) service application servers, web service servers, email service servers, or SMS service servers. The term “real-time reservation information” refers to information about reservation products for rooms that have been sold through the broker server 200. This may include information necessary for room reservations, such as reservation date, check-in time, number of rooms, room type, number of beds, number of bathrooms, and number of guests. Real-time reservation information may also refer to reservation data for bundled products such as lodging packages or tourism packages.

In step S203, the room reservation decision unit 130 determines whether room assignment is required among the at least one real-time reservation information. If it is determined that room assignment is required, the room reservation decision unit 130 analyzes the reservation information of unassigned reservations and, in step S205, determines whether the scheduled check-in time falls within a critical time range. The room reservation decision unit 130 may determine whether the reservation information received from the sales information database 110 includes the need for room assignment. For example, if the reservation pertains to a tourism package that does not include lodging, the unit may determine that room assignment is unnecessary.

If, in step S205, it is determined that the scheduled check-in time falls within the critical time range, then in step S207, the room reservation decision unit 130 selects the reservation as a target reservation and extracts room classification information stored in the reservation information. On the other hand, if the scheduled check-in time does not fall within the critical range, the unit may transmit a room assignment failure message and failure information regarding the reservation to the user terminal 400.

In step S209, the room reservation decision unit 130 transmits the reservation information and the room classification information for the target reservation to the room assignment management unit 140. The room classification information refers to categorized data extracted from the reservation information-such as user requests-to facilitate personalized room assignment. This may include preferences such as “high floor”, “ocean view”, or “traveling with two children”. The classification information may also include assignment priority, for example, first priority: connected rooms, second priority: ocean view, third priority: high floor. These priorities may be generated based on general user preferences or may be set according to lodging provider input.

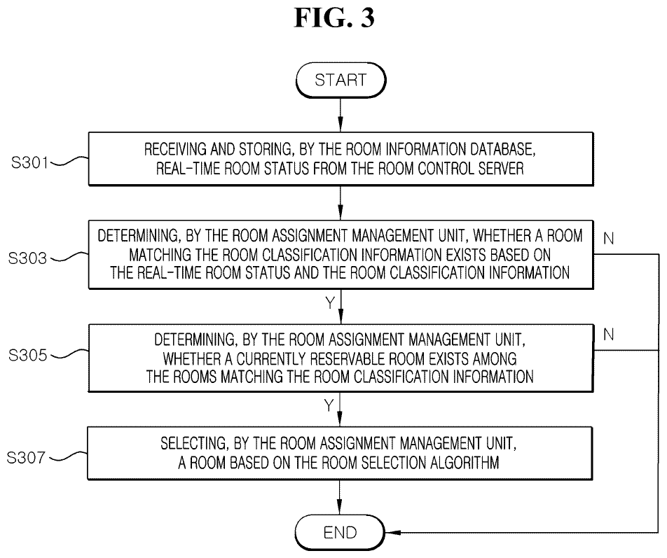

FIG. 3 is a flowchart illustrating a method for selecting assignable rooms based on reservation information corresponding to selected reservation, according to an embodiment of the present invention.

Referring to FIG. 3, in step S301, the room information database 120 receives and stores real-time room status from the room control server 300. The room control server 300 collects and transmits real-time room status data to the reservation management server 100. The room control server 300 may receive such data from one or more Room Control Units (RCUs), Central Control Units (CCUs), or directly from room vendors.

An RCU refers to a room-level controller, and a CCU refers to a centralized interface connected to multiple RCUs to collect room state data. The room control server 300 may collect real-time room status directly from RCUs or indirectly via CCUs communicating with multiple RCUs. The room status may include at least one of: room vacancy, cleaning status, maintenance status, prohibition status, or usage status of physical devices in the room. These physical devices may include, for example, lighting systems, air conditioners, temperature control units, door locks, or power supply devices. Furthermore, the room control server 300 may also receive room information such as room name, classification, scheduled check-in and check-out times from room vendors and store it as real-time status data.

In step S303, the room assignment management unit 140 determines whether there exists a room that matches the room classification information, based on the real-time room status and the room classification information received from the room reservation decision unit 130. If no matching room is found, the room assignment management unit 140 may transmit a room assignment failure message and failure information to the user terminal 400.

If it is determined in step S303 that one or more rooms match the room classification information, then in step S305, the room assignment management unit 140 determines whether there is at least one room among the matching rooms that is currently available for reservation. If such a reservable room exists, then in step S307, the room assignment management unit 140 selects an appropriate room using a room selection algorithm. The room selection algorithm may be generated based on selection criteria provided by the room vendor. It may include a machine learning algorithm or a traditional rule-based selection algorithm, though it is not limited to these.

If no room is currently available even among matching rooms, the room assignment management unit 140 may transmit a room assignment failure message and failure information to the user terminal 400.

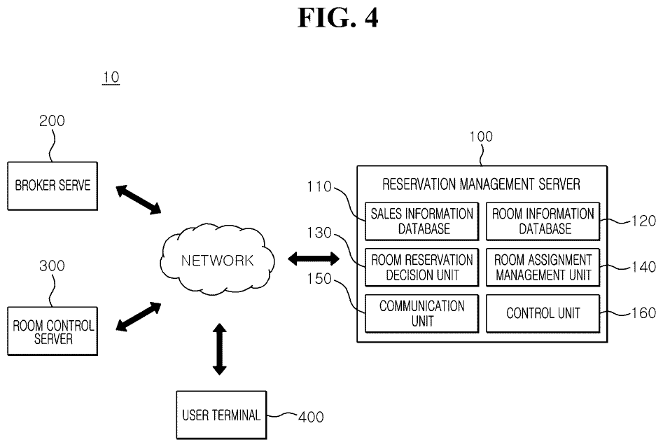

FIG. 4 is a block diagram illustrating the configuration of an automatic room assignment system based on real-time room sales information and room status information, according to an embodiment of the present invention.

Referring to FIG. 4, the automatic room assignment system 10 based on real-time room sales information and room status information includes a reservation management server 100, a broker server 200, a room control server 300, and a user terminal 400.

The reservation management server 100 is configured to: select reservations requiring room assignment; select assignable rooms based on the reservation information; assign a room to the corresponding reservation; and, upon completion or failure of assignment, transmit the corresponding result to the user terminal 400. The reservation management server 100 includes a sales information database 110, a room information database 120, a room reservation decision unit 130, a room assignment management unit 140, a communication unit 150, and a control unit 160.

The sales information database 110 receives and stores at least one real-time reservation information from the broker server 200. The real-time reservation information refers to data about rooms that have been sold, including details such as reservation date, check-in time, number of rooms, room type, number of beds, number of bathrooms, and number of guests. It may also include bundled product data, such as lodging packages or tourism packages. In particular, the real-time reservation information may include user-specific preferences, such as a request for wheelchair-accessible bathrooms.

The room information database 120 receives and stores real-time room status from the room control server 300. The room status may include room vacancy, cleaning status, prohibition status, malfunction status, and usage status of in-room physical devices such as lighting, air conditioning, temperature controls, door locks, or power switches. The room information database 120 may also store the assignment results for target reservations managed by the room assignment management unit 140.

The room reservation decision unit 130 determines whether room assignment is needed based on at least one real-time reservation information. If the reservation pertains to a tourism product with no accommodation included, the unit may determine that no room assignment is required. If room assignment is needed, the unit analyzes unassigned reservations to determine whether the check-in time falls within a user-defined critical time range. If so, the reservation is selected as a target reservation, and room classification information is extracted. The extracted information is then passed to the room assignment management unit 140. If not within the critical range, the unit transmits a failure message and reason to the user terminal 400.

The room classification information refers to categorized data used to support personalized assignment based on the reservation, such as “prefers high floor,” “prefers ocean view,” or “traveling with two children.” Priority may be assigned to each classification, e.g., 1 st: connected room, 2nd: ocean view, 3rd: high floor. This priority may be set based on general user preference patterns or directly by lodging providers.

The room assignment management unit 140 determines whether any rooms match the classification criteria based on the real-time room status and the classification information. If matching rooms exist, the unit checks whether any are currently available for reservation. If none are available, failure information is sent to the user terminal 400. If available rooms exist, the most appropriate one is selected using a room selection algorithm, which may be based on machine learning or vendor-defined rules. Once selected, the room is assigned to the target reservation. Usage information such as check-in and check-out time may also be transmitted to the user terminal 400.

The communication unit 150 enables communication between the reservation management server 100 and the broker server 200, room control server 300, and user terminal 400. Supported networks may include 3GPP, LTE, 5G, WiMAX, wired/wireless internet, LAN, WLAN, WAN, PAN, Bluetooth, Wi-Fi, NFC, satellite broadcasting, analog broadcasting, and DMB, without limitation.

The control unit 160, after failure messages are sent by the room reservation decision unit 130 or room assignment management unit 140, may further guide the user terminal 400 with follow-up procedures for assignment completion. These procedures may include retrying assignment, reanalyzing the failure cause, or using an alternative server due to errors in the broker server 200. The failure information may include specific causes for assignment failure. The broker server 200 collects real-time reservation data and transmits it to the reservation management server 100. It may gather information from multiple accommodation providers via OTA platforms or communication interfaces and support packaged reservation products. These products may also include user preferences, such as accessibility needs.

The room control server 300 collects real-time room status and transmits it to the reservation management server 100. It may do so via RCUs, CCUs, or directly from room vendors. RCUs serve as in-room control units, while CCUs manage multiple RCUs. The data collected may include room conditions and scheduled usage times.

While the invention has been described with reference to the embodiments shown in the drawings, this is for illustrative purposes only and it will be appreciated by those skilled in the art that various modifications and equivalent arrangements can be made therefrom. Accordingly, the true scope of technical protection of the present invention should be defined by the technical concept of the appended claims.

### DETAILED DESCRIPTION OF MAIN ELEMENTS

10 Automatic room assignment system based on real-time room sales and status information
100 Reservation management server
110 Sales information database
120 Room information database
130 Room reservation decision unit
140 Room assignment management unit
150 Communication unit
160 Control unit
200 Broker server
300 Room control server
400 User terminal

What is claimed is:

1. An automatic room assignment method based on real-time room sales information and room status information, comprising:
selecting, by a reservation management server, a reservation requiring room assignment;
selecting, by the reservation management server, an assignable room based on reservation information corresponding to the selected reservation;
assigning, by the reservation management server, a room corresponding to the selected reservation;
transmitting, by the reservation management server, room assignment completion to a user terminal when the room is successfully assigned; and
transmitting, by the reservation management server, room assignment failure and failure information to the user terminal when the room is not assigned.

2. The method of claim 1, wherein selecting a reservation requiring room assignment comprises:
receiving and storing, by a sales information database of the reservation management server, at least one real-time reservation information from a broker server;
determining, by a room reservation decision unit of the reservation management server, whether room assignment is required among the received real-time reservation information;
analyzing reservation information of an unassigned reservation if room assignment is required, and determining whether the scheduled check-in time is within a critical time range;
selecting the reservation as a target reservation if the check-in time is within the critical range and extracting room classification information from the reservation; and
transmitting the reservation information and the room classification information to a room assignment management unit of the reservation management server.

3. The method of claim 1, wherein selecting an assignable room based on reservation information comprises:
receiving and storing, by a room information database of the reservation management server, real-time room status from a room control server;
determining, by a room assignment management unit of the reservation management server, whether a room matching the room classification information received from the room reservation decision unit exists, based on the real-time room status;
determining whether at least one room is currently reservable among the matched rooms; and
selecting a room based on a room selection algorithm if at least one reservable room is available.

4. An automatic room assignment system based on real-time room sales information and room status information, comprising:
a reservation management server configured to receive and store at least one real-time reservation information from a broker server, receive and store room status from a room control server, select a reservation requiring room assignment, select an assignable room, assign the room, and transmit room assignment results to a user terminal;
the broker server configured to collect and transmit at least one real-time reservation information to the reservation management server;
the room control server configured to collect and transmit real-time room status to the reservation management server; and
the user terminal configured to receive at least one of room assignment completion, room assignment failure, and failure information from the reservation management server.

5. The system of claim 4, wherein the reservation management server comprises a room reservation decision unit and a room assignment management unit,
wherein the room reservation decision unit is configured to determine whether room assignment is required based on received reservation information, analyze reservation information of unassigned reservations, determine whether the scheduled check-in time is within a critical time range, select the reservation as a target reservation, extract room classification information from the reservation, and transmit the reservation information and the room classification information to the room assignment management unit,
and the room assignment management unit is configured to determine whether a room matching the room classification information exists based on real-time room status, determine whether such a room is reservable, and select a room based on a room selection algorithm.
